(19) United States
(12) Patent Application Publication
(10) Pub. No.: US 2023/0029192 A1
(43) Pub. Date: Jan. 26, 2023

(54) Metal Carbide Graphene Process

(71) Applicants: Justin W. Hendrix, Washington, DC (US); Carlos M. Murillo, King George, VA (US)

(72) Inventors: Justin W. Hendrix, Washington, DC (US); Carlos M. Murillo, King George, VA (US)

(73) Assignee: United States of America, as represented by the Secretary of the Navy, Arlington, VA (US)

(21) Appl. No.: 17/082,309

(22) Filed: Oct. 28, 2020

Related U.S. Application Data
(60) Provisional application No. 62/927,870, filed on Oct. 30, 2019.

(51) Int. Cl. C01B 32/184; B22F 9/04

(52) U.S. Cl. CPC C01B 32/184; B22F 9/04; B82Y 30/00

(57) ABSTRACT

A method is provided for producing metal hybrid graphene. The method includes providing a ball mill chamber filled with inert gas and metal balls; inserting graphene, nanographite, and nanosized transition metal; into the chamber; turning the chamber; and extracting the metal hybrid graphene. The transition metal is at least one of nickel, copper, cobalt, tungsten, iron, chromium and/or manganese.

### CROSS REFERENCE TO RELATED APPLICATION

Pursuant to 35 U.S.C. § 119, the benefit of priority from provisional application 62/927,870, with a filing date of Oct. 30, 2019, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to producing metalized graphene. In particular, the invention relates to graphene hybrid transition metal carbide production.

Graphene represents an artificial form of carbon atoms arranged in planar hexagons linked together. Graphene has desirable properties, such as high thermal and electrical conductivity, but large scale production is limited.

### SUMMARY

Conventional graphene production techniques yield disadvantages addressed by various exemplary embodiments of the present invention. In particular, various exemplary embodiments provide a method for metal hybrid graphene production. The method includes providing a ball mill chamber filled with inert gas and metal balls; inserting graphene, nanographite, and nanosized transition metal; into the chamber; turning the chamber; and extracting the metal hybrid graphene. The transition metal is at least one of nickel, copper, cobalt, tungsten, iron, chromium and/or manganese.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a diagram view of geometric carbon lattice deformations;

FIG. 2 is a diagram view of a carbon product geometries;

FIG. 3 is an elevation cross-section view of a ball mill;

FIG. 4 is a schematic view of graphene growth on substrate;

FIG. 5 is an isometric view of metalized graphene sheets;

FIG. 6 is a set of photographic views of copper-nickel alloys;

FIG. 7 is a diagram view of a milling process; and

FIG. 8 is a flowchart view of the exemplary process.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims. The disclosure generally employs quantity units with the following abbreviations: length in milimeteres (mm), mass in grams (g), time in hours (hr), volume in liters (L), angles in degrees (°), spin in revolutions per minute (rpm) and so forth.

This disclosure describes the development of an anisotropic graphene enhanced carbon-carbon composite used for macroscale thermal management and protection. Graphene represents a two-dimensional hexagonal lattice of carbon (C) atoms in a single atomic layer. Graphene has high strength, low density and high conductivity (thermal and electrical) compared to other materials. Exemplary embodiments provide graphene production techniques with metal carbide dispersed along edges to further enhance conductivity.

Graphene product is difficult to manufacture in large quantities, and so its use is primarily limited to research and development. Carbon atoms are typically arranged in other geometric configurations, most commonly as graphite and less commonly as diamond, both found in nature. Synthetic forms have been developed arranged in a microscopic spherical ball called fullerene and a cylindrical pipe called nanotube.

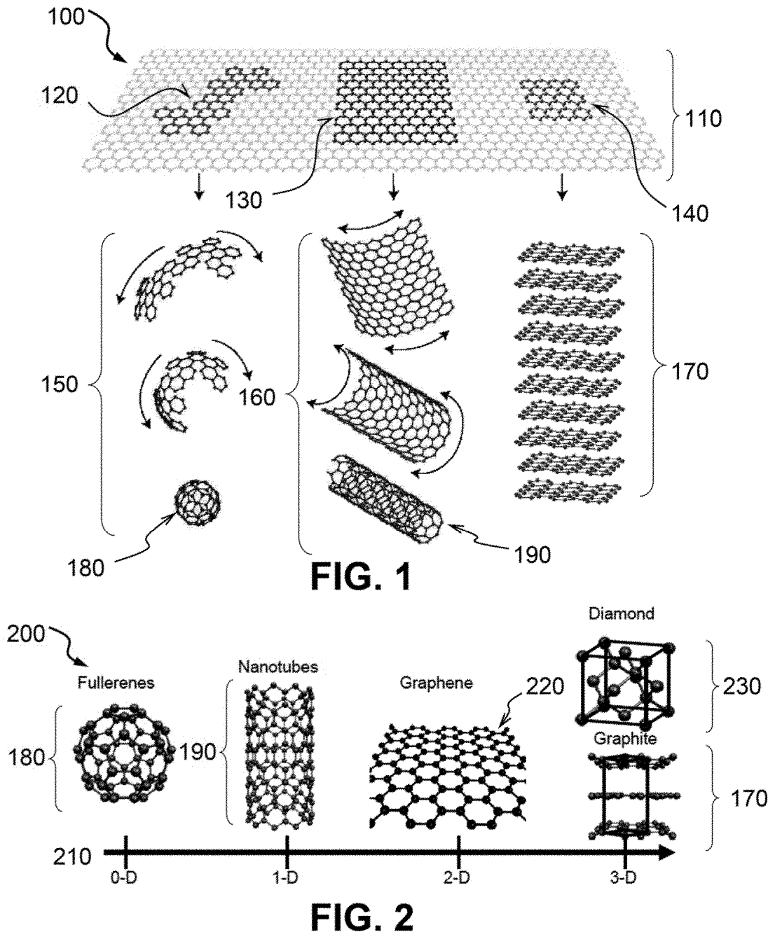

FIG. 1 shows a diagram view 100 of carbon atom arrangements from a sheet 110 of carbon atoms in hexagonal pattern. Note that a single carbon hexagon covalently bonds six such atoms. This sheet 110 can be separated into a sinusoidal template 120 (with twenty-two hexagons), a first rectangular template 130 (with eighty-three hexagons), and a second rectangular template 140 (with eighteen hexagons). Each template can be deformed to form other shapes.

In particular the template 120 curves along its length 150, the template 130 rolls along one side 160, and the template 160 laminates to form a series of layers to form graphene 170. The curving process 150 joins the curved ends to form a fullerene 180, which in closed spherical form contains 60 carbon atoms. Closed ellipsoid forms typically have more than that. The rolling process 160 joins its rolled edges to form a nanotube 190. Commonly available techniques thus produce graphite 170, fullerenes 180 and nanotubes 190.

FIG. 2 shows a diagram view 200 of carbon structures compared to their dimensionality 210, which relates to orthogonal directions of extension. The fullerene 180 has zero dimension (0-D), while the nanotube 190 has one dimension (1-D). Graphene 220 has two-dimensions (2-D) as a flat sheet. Graphite 170 and diamond 230 have three-dimensions (3-D). Diamond 230 form under high temperature and pressure, such as in deep volcanoes in nature.

Graphene 220 and graphite 170 undergo reactive ball milling with catalytic metal nanopowder. The milling components will undergo mechanical plus chemical (mechano-chemical) changes over an increasing lifetime of the milling process. Metal hybrid graphene (MHG) and resulting nanographite undergo a high temperature heat treatment, results in the restoration of structural deformities caused by ball milling. The hybrid material can be characterized along each step of the process to identify desirable chemical modified surfaces that improve phonon transport for higher thermal conductivity.

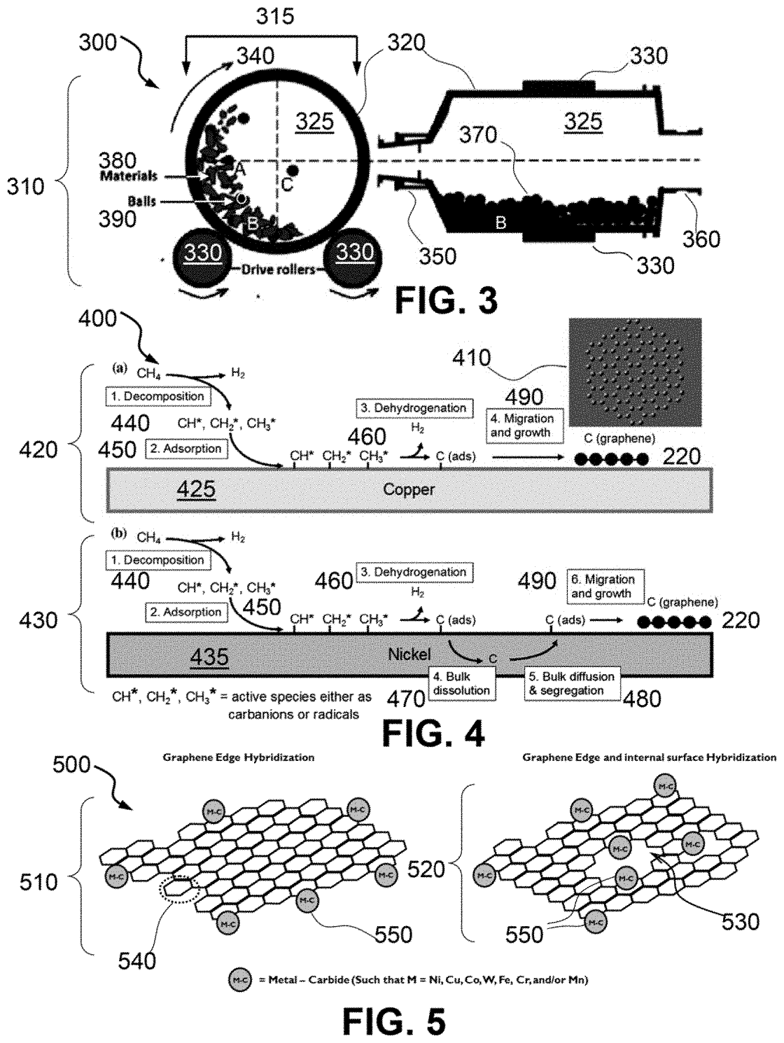

FIG. 3 shows elevation cross-section views 300 of ball mill 310, with the right side featuring cross-section 315 of the left side. A cylindrical housing 320 encloses an interior milling jar 325 with circular cross-section. A pair of drive rollers 330 turn the housing 320 anti-clockwise 340 as shown in view 300. The housing 320 includes an inlet 350 and an outlet 360. The interior 325 contains solids 370 that comprise raw starting materials 380 of carbon and metal balls 390 for milling deposited through the inlet 350, with MHG as the product. The housing 320 spins at a minimum of 60 rpm up to 300 rpm.

Interior labels A, B and C in view 300 represent components of the graphene formation process. Label A represents the carbon starting material consisting of graphite or graphene nanoplatelets. Label B is the resulting graphene carbide converted by the continuation of mechano-chemical events. Label C represent the ball milling media consisting of yittria stabilized zirconia (YSZ) or tungsten carbide (WC) as balls 390, where the milling media may contains sizes in the range of 3-10 mm and 10-30 mm. The milling media maintained to be considerably hard enough to reduce the size of and deform both graphite and graphene nanoplatelets.

The inert atmosphere within the milling jar 325 has been changed to an organic solvents comprising toluene (C₆H₅CH₃ or methylbenzene) and dimethyl formaldehyde ((CH₃)2NC(O)H or DMF). The atmosphere external to the housing 320 is inert, producing an external conversion zone against unintended contamination. Where the starting elemental concentration of the solvent consist of oxygen (O₂) and nitrogen (N₂) at less than 1% by mole concentration. As milling persists, the concentration of DMF is added at increasing milling times, dispersing in situ graphene carbides. The starting concentration of toluene is 10% to 50% volume of the milling jar 325 and the concentration of DMF is 0.1:1 to 1:1 volume concentration of toluene.

By elucidating the adsorption kinetics of carbon within a metal and metal alloy interface, one can find the alloying concentration that produces the highest carbon radical diffusivity. In this process, the formation of discrete metastable metal-carbides can be studied that are likely to aid in the evolution of graphene within a carbon-sourced matrix. Due to reactive ball milling graphene with copper (Cu), nickel (Ni), and a Cu/Ni catalyst, the combined solid-state reactions can be exploited for the purpose of low temperature structural refinement and growth of graphene in-situ. The resulting process aids the materials science community by shedding light on the nucleation kinetics of graphene 220 with transition metal catalysts and its formation from solid state methods.

FIG. 4 shows a schematic view 400 of graphene growth as a sheet 410 on a substrate. The first process 420 employs copper 425 as the substrate. The second process 430 employs nickel 435 as the substrate. The first step 440 involves decomposition of methane (CH₄) into hydrogen (H₂) and hydrocarbons (CH*, CH_{2*}, CH₃*), which are active species as either carbanions or radicals. The second step 450 involves adsorption of these hydrocarbons to the substrate of either copper 425 or nickel 435.

The third step 460 involves dehydrogenization, which releases the hydrogen from the adsorbed hydrocarbons, leaving the solid carbon (ads) on the substrate surface. The second process 430 includes two additional operations. The fourth step 470 involves bulk dissolution into the nickel 435, while the fifth step 480 involves bulk diffusion and segregation. The sixth step 490 for both processes 420 and 430 promotes migration and growth to form graphene 220.

FIG. 5 shows an isometric view 500 of graphene sheets 510 and 520, the latter containing a gap 530. Each sheet is composed of hexagons 540 of carbon atoms linked together at their corners. Metal-carbides (MC) 550 are disposed at intervals of two or more hexagons 540 with the MC 550 replacing one carbon atom at its hexagonal corner. The metal for these MC 550 additives can be nickel, copper, cobalt (Co), tungsten (W), iron (Fe), chromium (Cr) and/or manganese (Mn).

Exemplary embodiments describe a mechano-chemical process in which the starting materials consist of graphene, nanographite, and a single or multi-mixtures of nanosized transition metals for the creation of graphene hybrid transition metal carbides. The hybridized graphene as MHG is created such that the edge or surface of the graphene 220 forms an MC 550 of varying chemical coordination. The reaction of the carbon species with transition metals are conducted under a modified ball milling process, where the reacting atmosphere in the interior 325 is chemically inert and milling media is selected to dissipate heat for mechano-chemical hybridization to occur.

The milling container operates at a volume of 1 L where up to 50% or more of the volume consist of hard milling media (YSZ/WC). The process is ran for a minimum of 12 hr, where at least 10% of the dispersed material is reduced in size and converted to carbide. The milling process is started at room temperature, and converted for to the reaction time at ambient temperature conditions.

The exemplary conversion of the starting material occurs when mechano-chemical reactions causes the fracturing of graphite or graphene nanoplatelets, creating new high potential energy surface. These novel fracture surfaces are newly created reactive surface of free radical carbon in the graphitic material. Free radicals, based on surrounding chemistry and temperature, create conditions for graphene carbides to form.

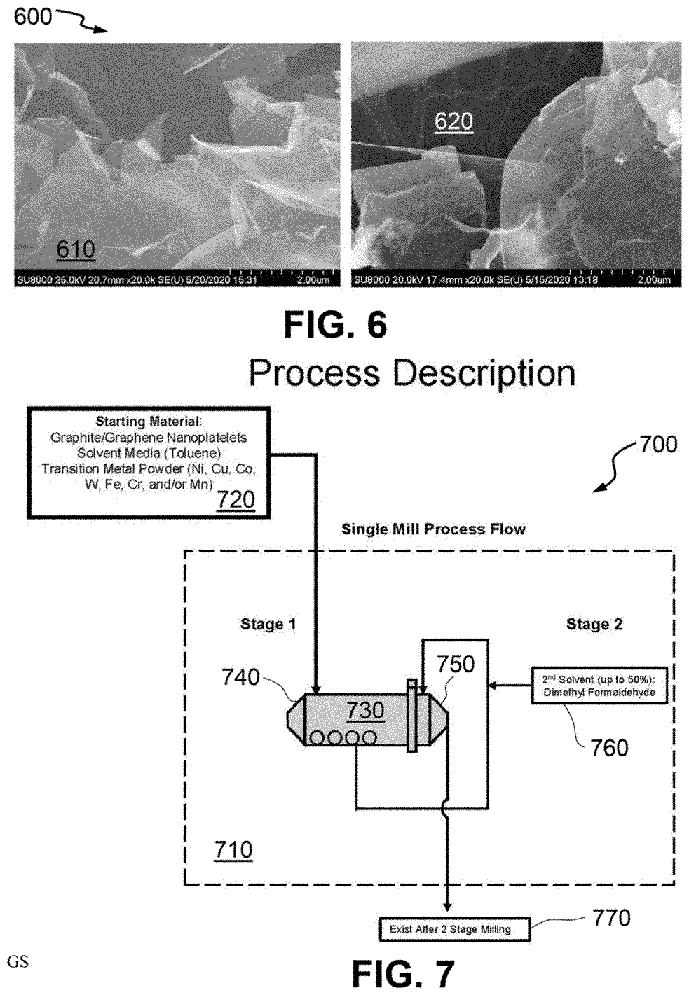

FIG. 6 shows photograph views 600 of copper-nickel alloys of regions having a length of 2.0 μm after milling. The left photograph 610 shows the CuNi alloy with graphene nanoplatelets, while the right photograph 620 shows the CuNi alloy with graphite.

FIG. 7 shows a diagram view 700 of the exemplary fabrication milling process 710 for a single mill. Starting materials 720 include graphite and graphene nanoplatelets, a first solvent composed of toluene, and transition metal powder, as described for view 300. In the first stage, a chamber 730 (analogous to the housing 320) receives the starting materials 720 at its receptacle end 740 opposite the egress end 750. Partially processed material is diverted to be combined at the second stage to a second solvent 760 composed of DMF and returned to the egress end 750. The resulting processed material 770 is removed from the egress end 750.

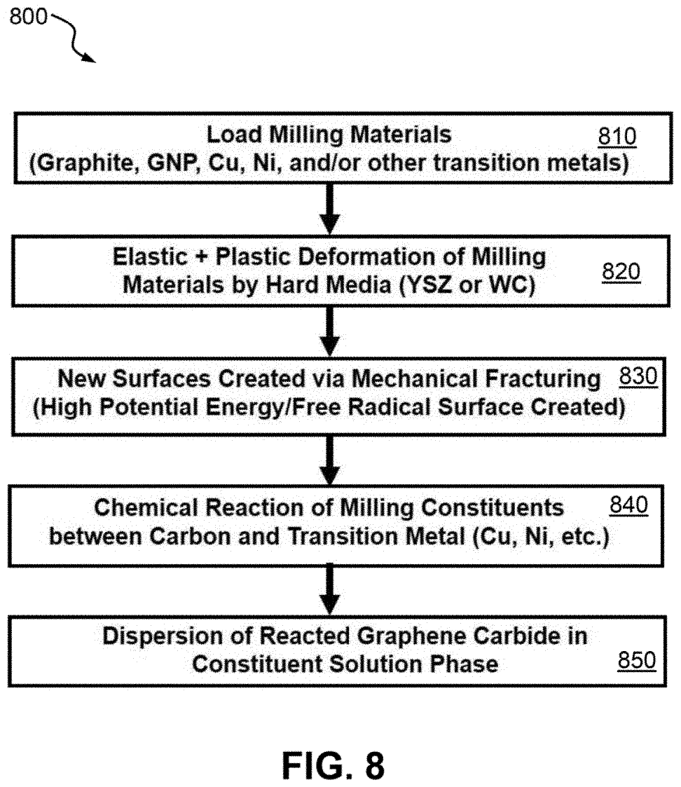

FIG. 8 shows a flowchart view 800 of the exemplary process. First, milling starting materials 720 are loaded 810. Second, these materials undergo elastic and plastic deformation 820 by hard media (YSZ or WC). Third, mechanical fracturing 830 produces new surfaces, resulting in high potential energy and free radical surfaces. Fourth, chemical reaction 840 of these milling constituents occurs between the carbon and transition metal (e.g., Cu or Ni). Finally, the reacted graphene carbide is dispersed in a constituent solution 850 for transfer to its intended purpose, such as for relevant construction.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method for producing metal hybrid graphene, said method comprising:
providing a ball mill chamber filled with inert gas and metal balls;
inserting graphene, nanographite, and a nanosized transition metal; into said chamber;
turning said chamber; and
extracting the metal hybrid graphene.

2. The method according to claim 1, wherein said chamber includes an interior surface of copper.

3. The method according to claim 1, wherein said chamber includes an interior surface of nickel.

4. The method according to claim 1, wherein said transition metal is at least one of nickel, copper, cobalt, tungsten, iron, chromium and/or manganese.

5. The method according to claim 1, wherein said metal balls are composed of at least one of yittria stabilized zirconia and tungsten carbide.

6. The method according to claim 1, wherein said inert gas is composed of at least one of toluene and dimethyl formaldehyde.
